(19) United States
(12) Patent Application Publication
(10) Pub. No.: US 2014/0356572 A1
(43) Pub. Date: Dec. 4, 2014

(54) WINDOW STRUCTURE AND METHOD OF MANUFACTURING A DISPLAY DEVICE HAVING THE SAME

(71) Applicant: Samsung Display Co., LTD., Yongin-City (KR)

(72) Inventors: Hun-Kyo KIM, Cheonan-si (KR); Ju-Suk OH, Cheonan-si (KR); Seong-Jin HWANG, Jinju-si (KR)

(73) Assignee: Samsung Display Co., LTD., Yongin-City (KR)

(21) Appl. No.: 14/057,980

(22) Filed: Oct. 18, 2013

(30) Foreign Application Priority Data
Jun. 3, 2013 (KR) 10-2013-0063290

(51) Int. Cl. B32B 27/08; B32B 27/30; B32B 27/36

(52) U.S. Cl. CPC B32B 27/08; B32B 27/36; B32B 27/365; B32B 27/308; B32B 2250/04; B32B 2250/05; B32B 2250/24; B32B 2255/10; B32B 2255/26; B32B 2307/412; B32B 2457/20
USPC 428/128; 428/697; 428/412; 428/447; 428/446; 427/58

(57) ABSTRACT

The present disclosure relates to a display device including a window structure having improved durability and reliability, and a method of manufacturing the display device. The window structure includes a first transparent film layer, a second transparent film layer disposed on the first transparent film layer, a third transparent film layer disposed on the second transparent film layer, and a coating layer disposed on an upper surface of the window structure.

### CROSS-REFERENCE TO RELATED APPLICATION

This application claims priority under 35 U.S.C. §119 to Korean Patent Application No. 10-2013-0063290 filed on Jun. 3, 2013, the entire contents of which are herein incorporated by reference.

### BACKGROUND

1. Technical Field

The present disclosure relates to a display device. More particularly, the present disclosure relates to a display device including a window structure having improved durability and reliability, and a method of manufacturing the display device.

2. Description of the Related Art

Generally, a window is formed over a display panel in an electronic device (such as a cellular phone, a portable multimedia player (PMP), etc.) to protect the display panel. Tempered glass is typically used in conventional windows. Recently, plastics have been developed to replace the tempered glass in conventional windows. However, plastics may have inferior strength compared to tempered glass. Also, plastics windows may have poor adhesion to the display panel. As a result, existing plastics windows may be unable to meet the durability and reliability requirements for electronic devices.

### SUMMARY

The present disclosure is directed to address at least the above problems relating to the durability and reliability of electronic devices having plastics windows.

According to some embodiments of the inventive concept, a window structure is provided. The window structure includes a first transparent film layer, a second transparent film layer disposed on the first transparent film layer, a third transparent film layer disposed on the second transparent film layer, and a coating layer disposed on an upper surface of the window structure.

In some embodiments, the coating layer may have a horizontal width and a longitudinal width that are substantially the same as a horizontal width and a longitudinal width of the first through third transparent film layers, respectively.

In some embodiments, the coating layer may include a UV absorber having an organic pigment, the organic pigment including at least one of a benzophenone-based dye, a benzotriazol-based dye, a triazine-based dye, an azo-based dye, an amino ketone-based dye, a xanthene-based dye, a quinoline-based dye, and an anthraquinone-based dye.

In some embodiments, the coating layer may include a blue pigment, the blue pigment including at least one of cobalt blue (CoAₗ₂O₄), ultramarine (Na₇Al₆Si₆O₂₄S₃), azurite (Cu₃(CO₃)₂(OH)₂), and prussian blue (Fe₄[Fe(CN)₆]₃).

In some embodiments, the first and third transparent film layers may include at least one of polycarbonate (PC), polyethylene terephthalate (PET), and polymethyl methacrylate (PMMA), and the second transparent film layer may include a silicone elastomer.

In some embodiments, a UV absorber having an organic pigment may be omitted from the second transparent film layer, the organic pigment including at least one of a benzophenone-based dye, a benzotriazol-based dye, a triazine-based dye, an azo-based dye, an amino ketone-based dye, a xanthene-based dye, and a quinoline-based dye.

In some embodiments, the window structure may further include a first adhesive member disposed between the first transparent film layer and the second transparent film layer, and a second adhesive member disposed between the second transparent film layer and the third transparent film layer.

In some embodiments, the first and second adhesive members may include at least one of an optically clear adhesive (OCA) and a super view resin (SVR).

In some embodiments, the window structure may further include a coating layer extending from the upper surface of the window structure so as to cover both sides of the window structure.

According to some embodiments of the inventive concept, a method of manufacturing a display device is provided. The method includes forming a window structure on a display panel, wherein the display panel includes a switching device, a first electrode, a light emitting structure, and a second electrode, and forming the window structure includes: forming a first transparent film layer on the display panel, forming a second transparent layer on the first transparent film layer, forming a third transparent layer on the second transparent layer, and forming a coating layer on an upper surface of the window structure.

In some embodiments, the coating layer may have a horizontal width and a longitudinal width that are substantially the same as a horizontal width and a longitudinal width of the first through third transparent film layers, respectively.

In some embodiments, forming the coating layer may include coating the coating solution using at least one of a spray process, a slit coating process, a bar coating process, and a spin coating process, and removing a solvent from the coating solution by a baking process, wherein the coating solution may include a blue pigment and a UV absorber having an organic pigment, the organic pigment including at least one of a benzophenone-based dye, a benzotriazol-based dye, a triazine-based dye, an azo-based dye, an amino ketone-based dye, a xanthene-based dye, a quinoline-based dye, and an anthraquinone-based dye, and the blue pigment including at least one of cobalt blue, ultramarine, azurite, and prussian blue.

In some embodiments, the first and third transparent film layers may include at least one of polycarbonate, polyethylene terephthalate, and polymethyl methacrylate, the second transparent film layer may include a silicone elastomer, and a UV absorber having an organic pigment may be omitted from the second transparent film, the organic pigment including at least one of a benzophenone-based dye, a benzotriazol-based dye, a triazine-based dye, an azo-based dye, an amino ketone-based dye, a xanthene-based dye, and a quinoline-based dye.

In some embodiments, the method may further include forming a first adhesive member between the first transparent film layer and the second transparent film layer, and forming a second adhesive member between the second transparent film layer and the third transparent film layer.

In some embodiments, the method may further include forming a third adhesive member between the display panel and the window structure, wherein the display panel is attached to the window structure using the third adhesive member.

In some embodiments, the first through third adhesive members may include an optically clear adhesive (OCA) or a super view resin (SVR).

In some embodiments, the method may further include forming a coating layer extending from the upper surface of the window structure so as to cover both sides of the window structure.

### BRIEF DESCRIPTION OF THE DRAWINGS

FIG. 1 is a perspective view illustrating a window structure according to an embodiment of the inventive concept.

FIG. 2 is a cross-sectional view of the window structure of FIG. 1.

FIG. 3 is a perspective view illustrating a window structure according to another embodiment.

FIG. 4 is a cross-sectional view of the window structure of FIG. 3.

FIGS. 5A and 5B are flow charts illustrating a method of manufacturing a display device in accordance with some embodiments.

FIGS. 6 through 10 depict cross-sectional views of the display device at different stages of fabrication according to the method of FIGS. 5A and 5B.

FIG. 11 is a cross-sectional view illustrating a display panel including the display device of FIG. 10.

### DETAILED DESCRIPTION

The inventive concept will be described more fully herein with reference to the accompanying drawings, in which different embodiments are shown. The inventive concept may be embodied in different forms and should not be construed as being limited to the described embodiments. The embodiments disclose and convey the scope of the inventive concept to those skilled in the art. In the drawings, the sizes and relative sizes of layers and regions may have been exaggerated for clarity. Like numerals refer to like elements throughout.

It will be understood that although the terms “first,” “second,” “third,” etc. may be used herein to describe various elements, the elements should not be limited by those terms. Instead, those terms are merely used to distinguish one element from another. Thus, a first element could be renamed as a second element without departing from the teachings of the inventive concept. As used herein, the term “and/or” includes any and all combinations of one or more of the associated listed items.

It will be understood that when an element is referred to as being “connected” or “coupled” to another element, it can be directly connected or coupled to the other element, or connected or coupled to the other element with one or more intervening elements. In contrast, when an element is referred to as being “directly connected” or “directly coupled” to another element, there is no intervening element present between the two elements. In addition, words that are used to describe the relationship between elements should be interpreted in a like fashion (e.g., “between” versus “directly between,” “adjacent” versus “directly adjacent,” etc.).

The terminology used herein for describing the embodiments is not intended to limit the inventive concept. As used herein, the singular forms “a,” “an,” and “the” are intended to include plural forms unless the context clearly indicates otherwise. It will be further understood that the terms “comprises” and/or “comprising” specify the presence of stated features, integers, steps, operations, elements, and/or components, but do not preclude the presence or addition of one or more other features, integers, steps, operations, elements, components, and/or groups.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art, and should not be interpreted in an idealized or overly formal sense unless expressly defined herein.

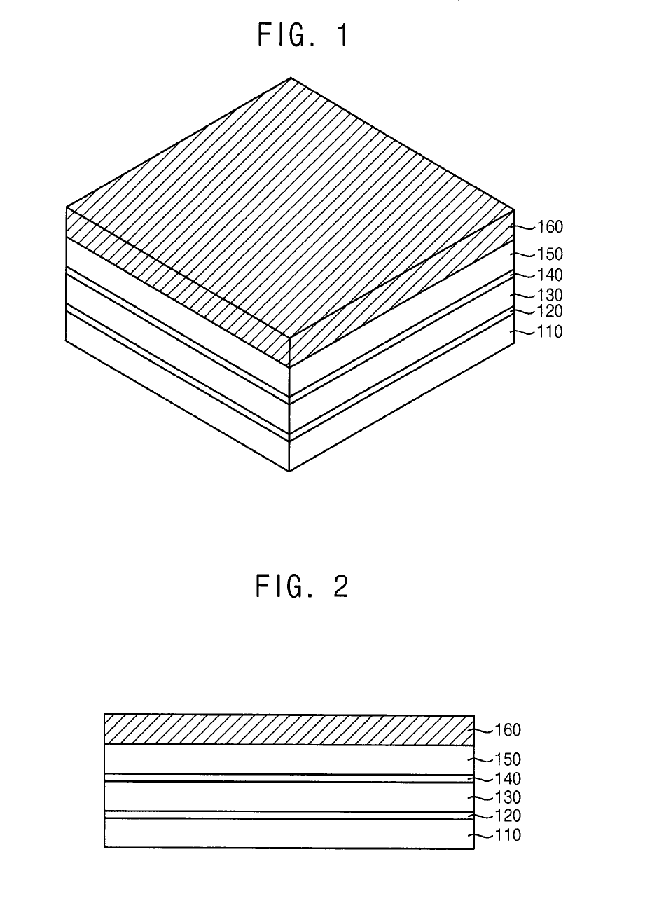

FIG. 1 is a perspective view illustrating a window structure according to an embodiment of the inventive concept. FIG. 2 is a cross-sectional view of the window structure of FIG. 1.

Referring to FIGS. 1 and 2, the window structure may include a first transparent film layer 110, a second transparent film layer 130, a third transparent film layer 150, and a coating layer 160. The window structure may be disposed on a display panel (not shown).

The first, second, and third transparent film layers 110, 130 and 150 may include plastics (i.e. polymer resins). In some embodiments, the first and third transparent film layers 110 and 150 may include substantially the same plastics material, and the second transparent film layer 130 may include a plastics material that is different from the plastics material used in the first and third transparent film layers 110 and 150.

In some embodiments, the first and third transparent film layers 110 and 150 may include polycarbonate (PC), polyethylene terephthalate (PET), polymethacrylate (PMMA), or other similar materials. In some embodiments, the second transparent film layer 130 may include a silicone elastomer (e.g. Silplus™). In some particular embodiments, the second transparent film layer 130 may include a plastics material that is substantially the same as the plastics material used in the first and third transparent film layers 110 and 150.

A conventional plastics window structure typically includes a transparent film layer having a UV absorber for reducing the yellowing phenomenon generated by UV light. The UV absorber may include an organic pigment, and the organic pigment may include at least one of the following dyes: benzophenone-based dye, benzotriazol-based dye, triazine-based dye, azo-based dye, amino ketone-based dye, xanthene-based dye, and quinoline-based dye. However, a UV absorber having an organic pigment may cause degradation in adhesion between the window structure and display panel. Thus, in some embodiments of the inventive concept, a UV absorber having an organic pigment may be omitted from the second transparent film 130, so as to improve the adhesion between the window structure and display panel. Accordingly, the window structure in those embodiments may have improved durability and reliability compared to the conventional plastics window structures.

As shown in FIGS. 1 and 2, a first adhesive member 120 may be interposed between the first transparent film layer 110 and the second transparent film layer 130. A second adhesive member 140 may be interposed between the second transparent film layer 130 and the third transparent film layer 150. In some embodiments, the first and second adhesive members 120 and 140 may include substantially the same material. For example, the first and second adhesive members 120 and 140 may include at least one of an optically clear adhesive (OCA) and super view resin (SVR).

The coating layer 160 may include a blue pigment and a UV absorber having an organic pigment. The organic pigment may include at least one of the following dyes: benzophenone-based dye, benzotriazol-based dye, triazine-based dye, azo-based dye, amino ketone-based dye, xanthene-based dye, quinoline-based dye, and anthraquinone-based dye. The blue pigment may include at least one of cobalt blue (CoAₗ₂O₄), ultramarine (Na₇Al₆Si₆O₂₄S₃), azurite (Cu₃(CO₃)₂(OH)₂), and prussian blue (Fe₄[Fe(CN)₆]₃). The coating layer 160 may have a thickness of about 20 μm. The coating layer 160 may serve to mitigate the increase in yellow index due to UV light. Accordingly, the durability and reliability of the window structure in FIGS. 1 and 2 may be improved due to the reduction in yellow index.

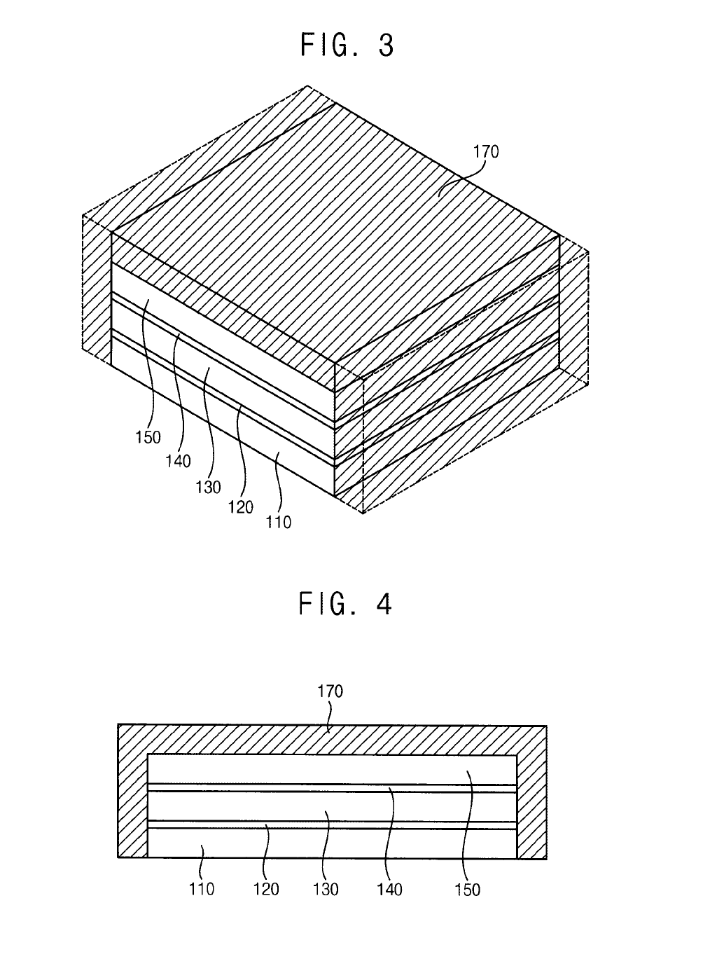

FIG. 3 is a perspective view illustrating a window structure according to another embodiment of the inventive concept. FIG. 4 is a cross-sectional view of the window structure of FIG. 3. The window structure of FIGS. 3 and 4 is similar to the window structure of FIGS. 1 and 2 except for some differences in the coating layer, as described below.

Referring to FIGS. 3 and 4, a coating layer 170 may be disposed on a third transparent film layer 150. In some embodiments, the coating layer 170 may be disposed extending from an upper surface of the window structure and covering both sides of the window structure.

In some embodiments, the coating layer 170 may include a blue pigment and a UV absorber having an organic pigment. The organic pigment may include at least one of the following dyes: benzophenone-based dye, benzotriazol-based dye, triazine-based dye, azo-based dye, amino ketone-based dye, xanthene-based dye, quinoline-based dye, and anthraquinone-based dye. The blue pigment may include at least one of cobalt blue, ultramarine, azurite, and prussian blue. The coating layer 170 may have a thickness ranging from about 5 μm to about 20 μm. In some embodiments, the coating layer 170 preferably has a thickness of about 15 μm. Similar to the coating layer 160, the coating layer 170 can help to mitigate the increase in yellow index due to UV light. Accordingly, the durability and reliability of the window structure in FIGS. 3 and 4 may be improved due to the reduction in yellow index.

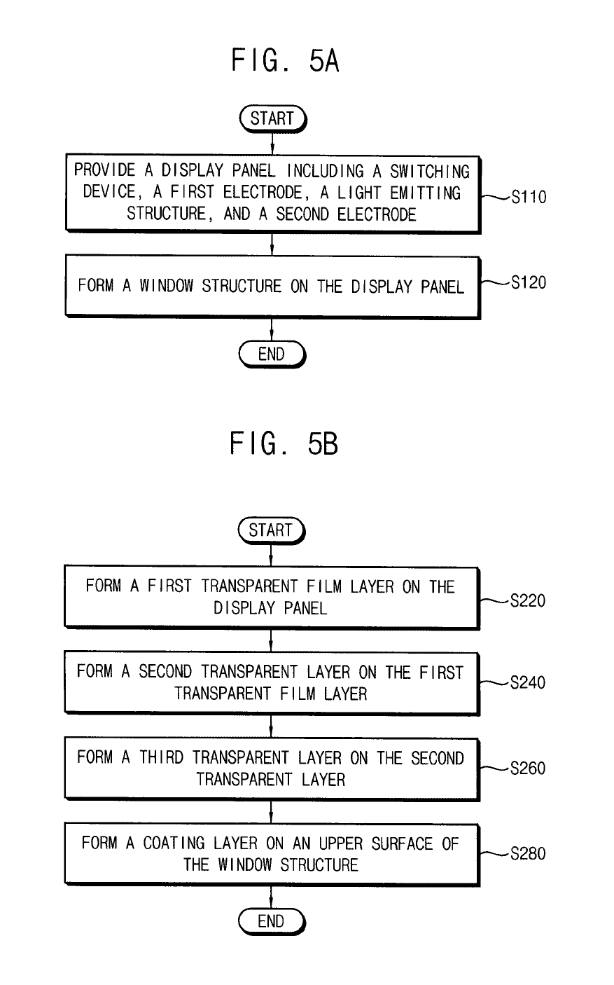

FIGS. 5A and 5B are flow charts illustrating a method of manufacturing a display device according to some embodiments of the inventive concept.

Referring to FIG. 5A, a display panel is first provided in Step 110. The display panel includes a switching device, a first electrode, a light emitting structure, and a second electrode. Next, a window structure is formed on the display panel (Step S120).

FIG. 5B illustrates the steps for forming the window structure. In Step 220, a first transparent film layer is formed on the display panel. Next, a second transparent layer is formed on the first transparent film layer (Step S240) and a third transparent layer is then formed on the second transparent layer (Step S260). Lastly, a coating layer is formed on an upper surface of the window structure (Step S280).

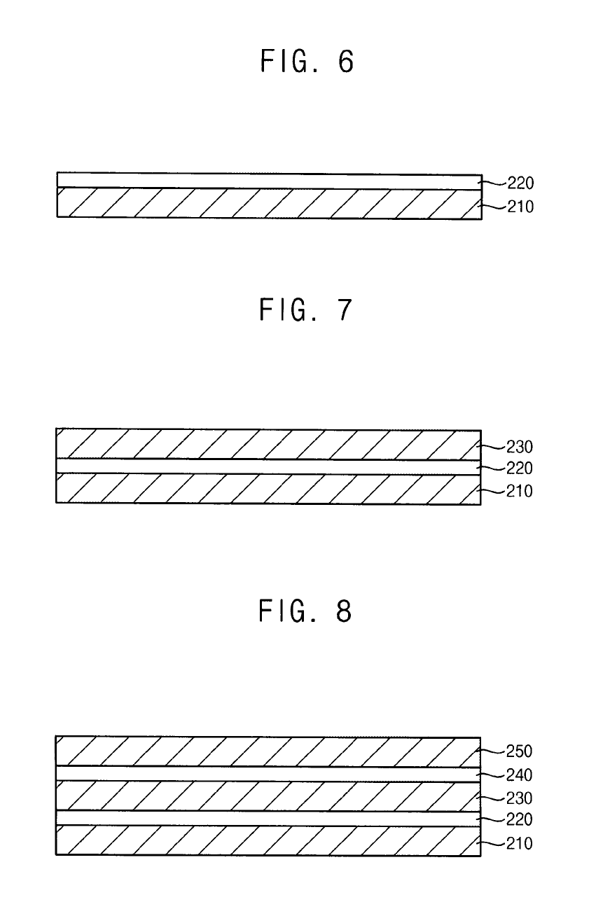

FIGS. 6 through 10 depict cross-sectional views of the display device at different stages of fabrication according to the method of FIGS. 5A and 5B.

With reference to FIG. 6, a first transparent film layer 210 may be formed on a display panel (not shown). The first transparent film layer 210 may include plastics (i.e. polymer resins). In some embodiments, the first transparent film layer 210 may include polycarbonate, polyethylene terephthalate, polymethacrylate, or other similar materials. As shown in FIG. 6, a first adhesive member 220 may be formed on the first transparent film layer 210. The first adhesive member 220 may include at least one of an optically clear adhesive and a super view resin.

As illustrated in FIG. 7, a second transparent film layer 230 may be formed on the first adhesive member 220. The second transparent film layer 230 may include plastics (i.e. polymer resins). In some embodiments, the second transparent film layer 230 may include a plastics material that is different from the plastics material used in the first transparent film layer 210. In some embodiments, the second transparent film layer 230 may include a silicone elastomer (Silplus™). As previously mentioned, a UV absorber having an organic pigment in the second transparent film may cause degradation in adhesion between the window structure and display panel. The organic pigment may include at least one of the following dyes: benzophenone-based dye, benzotriazol-based dye, triazine-based dye, azo-based dye, amino ketone-based dye, xanthene-based dye, and quinoline-based dye. Thus, in some embodiments, a UV absorber having an organic pigment may be omitted from the second transparent film 130, so as to improve the adhesion between the window structure and display panel.

As illustrated in FIG. 8, a second adhesive member 240 may be formed on the second transparent film layer 230, and a third transparent film layer 250 may be formed on the second adhesive member 240. In some embodiments, the second adhesive member 240 may include at least one of an optically clear adhesive and a super view resin. The third transparent film layer 250 may include plastics (i.e. polymer resins). In some embodiments, the third transparent film layer 250 may include polycarbonate, polyethylene terephthalate, polymethacrylate, or other similar materials.

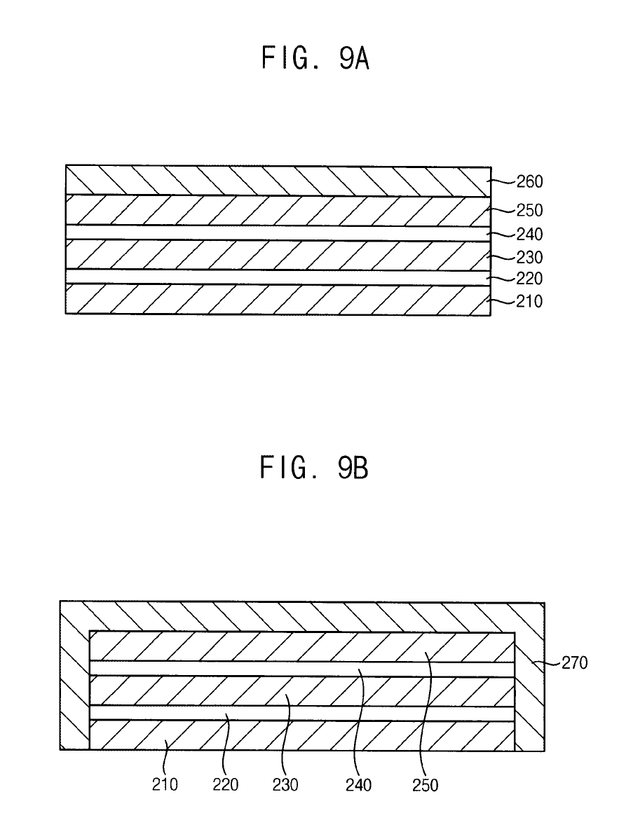

As illustrated in FIG. 9A, a coating layer 260 may be formed on the third transparent film layer 250. Similarly, a coating layer 270 may be formed on the third transparent film layer 250 in FIG. 9B. The window structures in FIGS. 9A and 9B may be similar to the respective window structures illustrated in FIGS. 2 and 4.

In some embodiments, a coating solution may be used to form the coating layers 260 and 270. The coating solution may include a UV absorber and a blue pigment. The organic pigment may include at least one of the following dyes: benzophenone-based dye, benzotriazol-based dye, triazine-based dye, azo-based dye, amino ketone-based dye, xanthene-based dye, quinoline-based dye, and anthraquinone-based dye. The blue pigment may include at least one of cobalt blue, ultramarine, azurite, and prussian blue. In some embodiments, the coating solution may be coated on the third transparent film layer 250 using at least one of the following processes: spray process, slit coating process, bar coating process, and spin coating process. After the coating solution has been coated on the third transparent film layer 250, the solvent in the coating solution may be removed by a baking process, thereby forming the coating layers 260 and 270 on the third transparent film layer 250.

In the example of FIG. 9A, the coating layer 260 may be formed on an upper surface of the window structure. The coating layer 260 may have a horizontal width and a longitudinal width that are substantially the same as a horizontal width and a longitudinal width of the first, second and third transparent film layers 110, 130 and 150, respectively. In contrast to FIG. 9A, the coating layer 270 in FIG. 9B may be formed extending from an upper surface of the window structure and covering both sides of the window structure.

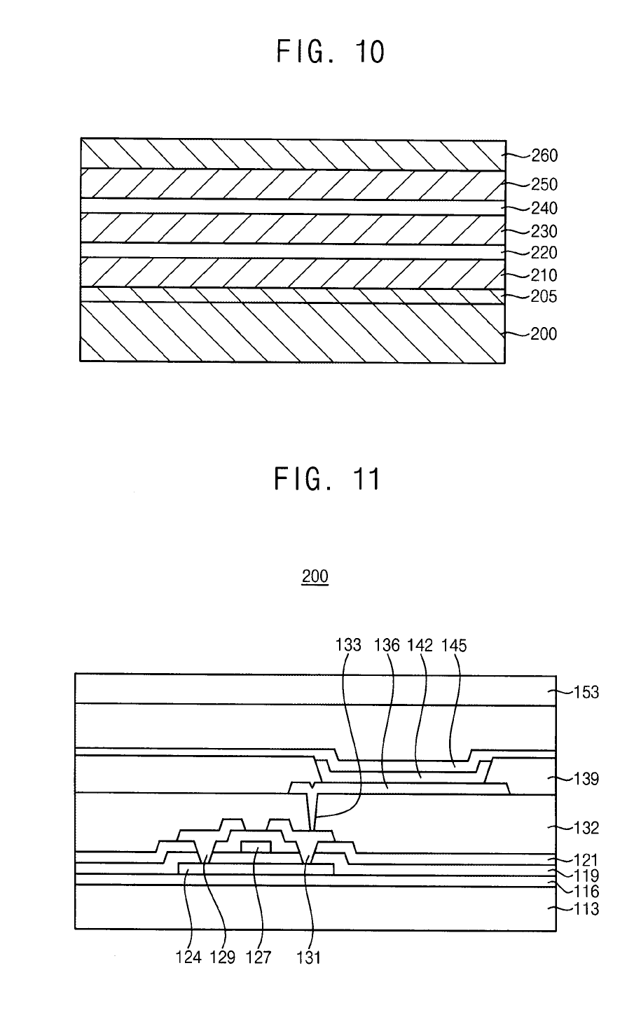

As illustrated in FIG. 10, a third adhesive member 205 may be interposed between a display panel 200 and the window structure of FIG. 9A. The third adhesive member 205 serves to attach the window structure to the display panel 200. It is noted that the display device of FIG. 10 is not limited to the aforementioned configuration, and the window structure in FIG. 10 may be replaced by any of the window structures illustrated in FIGS. 2, 4, and 9B.

In some embodiments, the third adhesive member 205 may include at least one of an optically clear adhesive and a super view resin. In some embodiments, UV light (e.g. generated from a UV lamp) may be irradiated onto the third adhesive member 205 so as to cure the third adhesive member 205. The display panel 200 and the window structure are attached (bonded) together at the end of the bonding process. Furthermore, by removing the UV absorber from the transparent film layer in the window structure, the hardening rate of the third adhesive member 205 may be improved. As previously mentioned, the window structure may include a coating layer having a UV absorber and a blue pigment, which helps to mitigate the increase in yellow index. Accordingly, the durability and reliability of the window structure in FIG. 10 may be improved due to the reduction in yellow index.

FIG. 11 is a cross-sectional view illustrating a display panel including the display device of FIG. 10.

Referring to FIG. 11, a display panel 200 may include an organic light emitting display (OLED) panel. However, the inventive concept is not limited to an OLED panel. For example, in some other embodiments, the display panel 200 may include a liquid crystal display (LCD) panel, a plasma display panel, etc.

The display panel 200 may include a first substrate 113, a switching device, a first electrode 136, a light emitting structure 142, a second electrode 145, a second substrate 153, etc.

As shown in FIG. 11, a buffer layer 116 may be disposed on the first substrate 113. The first substrate 113 may include a transparent insulating substrate, such as a glass substrate, quartz substrate, transparent resin substrate, or other similar substrates. A transparent resin substrate may include polyimide-based resin, acryl-based resin, polyacrylate-based resin, polycarbonate-based resin, polyether-based resin, sulfonic acid-containing resin, polyethyleneterephthalate-based resin, or other similar types of resins.

In some embodiments, the buffer layer 116 may prevent diffusion of metal atoms and/or impurities from the first substrate 113. An active pattern 124 may be formed on the buffer layer 116 using a crystallization process. It is noted that the heat transfer rate during the crystallization process may be modulated by the presence of the buffer layer 116. A substantially uniform active pattern 124 may then be formed as a result of the uniform heat transfer rate. Furthermore, the buffer layer 116 may improve the flatness of the first substrate 113 by providing a planar top surface. The buffer layer 116 may include a silicon compound. For example, the buffer layer 116 may include at least one of silicon oxide (SiOx), silicon nitride (SiNx), silicon oxynitride (SiOxNy), silicon oxycarbide (SiOxCy), silicon carbon nitride (SiCxNy), and other similar materials. The buffer layer 116 may be formed having a single layer structure or a multi-layer structure. For example, the buffer layer 116 may be formed having a single layer structure including a silicon oxide film, silicon nitride film, silicon oxynitride film, silicon oxycarbide film, or silicon carbon nitride film. Alternatively, the buffer layer 116 may be formed having a multi-layer structure including at least two of a silicon oxide film, silicon nitride film, silicon oxynitride film, silicon oxycarbide film, or silicon carbon nitride film.

The switching device may be disposed on the buffer layer 116. In some embodiments, the switching device may include a thin film transistor (TFT) having the active pattern 124. The active pattern 124 may include silicon (Si). The switching device may also include a gate insulating layer 119, a gate electrode 127, a source electrode 129, a drain electrode 131, etc. In some embodiments, the switching device may include an oxide semiconductor device having an active pattern 124. In those embodiments, the active pattern 124 may include semiconductor oxides.

The active pattern 124 may be disposed on the buffer layer 116. The active pattern 124 may include a source region and a drain region, both of which are doped with impurities. In addition, the active pattern 124 may include a channel region disposed between the source region and drain region.

In some embodiments, a semiconductor layer may be formed on the buffer layer 116, and a preliminary active layer may be formed on the buffer layer 116 by patterning the semiconductor layer. A crystallization process may be performed on the preliminary active layer to form the active pattern 124 on the buffer layer 116. In some embodiments, the semiconductor layer may include amorphous silicon and the active pattern 124 may include polysilicon. The crystallization process for forming the active pattern 124 may include a laser irradiation process, thermal treatment process, thermal process utilizing a catalyst, etc.

The gate insulating layer 119 may be disposed on the buffer layer 116 covering the active pattern 124. The gate insulating layer 119 may include silicon oxide, metal oxide, etc. Examples of the metal oxide in the gate insulating layer 119 may include hafnium oxide (HfOx), aluminum oxide (AlOx), zirconium oxide (ZrOx), titanium oxide (TiOx), tantalum oxide (TaOx), etc. A metal oxide may be included alone or in combination with other metal oxides. In some embodiments, a gate insulating layer 119 may be uniformly disposed on the buffer layer 116 along a profile of the active pattern 124. In some embodiments, the gate insulating layer 119 may have a substantially small thickness, such that a stepped portion may be generated at a portion of the gate insulating layer 119 adjacent to the active pattern 124. In some other embodiments, the gate insulating layer 119 may have a relatively large thickness (to sufficiently cover the active pattern 124), such that the gate insulating layer 119 has a substantially level surface.

The gate electrode 127 may be disposed on the gate insulating layer 119. For example, the gate electrode 127 may be disposed on a portion of the gate insulating layer 119 where the active pattern 124 is located. The gate electrode 127 may be formed by forming a first conductive layer on the gate insulating layer 119 and etching the first conductive layer using a photolithography process. The gate electrode 127 may include a metal, alloy, conductive metal oxide, transparent conductive material, etc. For example, the gate electrode 127 may include at least one of aluminum (Al), an alloy containing aluminum, aluminum nitride (AlNx), silver (Ag), an alloy containing silver, tungsten (W), tungsten nitride (WNx), copper (Cu), an alloy containing copper, nickel (Ni), an alloy containing nickel, chrome (Cr), chrome nitride (CrNx), molybdenum (Mo), an alloy containing molybdenum, titanium (Ti), titanium nitride (TiNx), platinum (Pt), tantalum (Ta), tantalum nitride (TaNx), neodymium (Nd), scandium (Sc), strontium ruthenium oxide (SRO), zinc oxide (ZnOx), indium tin oxide (ITO), tin oxide (SnOx), indium oxide (InOx), gallium oxide (GaOx), indium zinc oxide (IZO), etc. In some embodiments, the gate electrode 127 may be formed having a single layer structure or a multi-layer structure. The single layer structure or multi-layer structure may include a metal film, alloy film, metal nitride film, conductive metal oxide film, and/or transparent conductive film.

An insulating interlayer 121 may be disposed on the gate insulating layer 119 covering the gate electrode 127. The insulating interlayer 121 may electrically insulate the source and drain electrodes 129 and 131 from the gate electrode 127. The insulating interlayer 121 may be formed having a substantially uniform thickness, and may be conformally formed on the gate insulating layer 119 along a profile of the gate electrode 127. Accordingly, a stepped portion may be generated at a portion of the insulating interlayer 121 adjacent to the gate electrode 127. The insulating interlayer 121 may include a silicon compound. For example, the insulating interlayer 121 may include at least one of silicon oxide, silicon nitride, silicon oxynitride, silicon oxycarbide, and silicon carbon nitride. In some embodiments, the insulating interlayer 121 may be formed having a single layer structure or a multi-layer structure. The single layer structure or multi-layer structure may include a silicon oxide film, silicon nitride film, silicon oxynitride film, silicon oxycarbide film, and/or silicon carbon nitride film.

As illustrated in FIG. 11, the source electrode 129 and drain electrode 131 may be disposed on the insulating interlayer 121. The source and drain electrodes 129 and 131 may be separated from each other by a predetermined distance substantially centered about the gate electrode 127. The source and drain electrodes 129 and 131 may be formed extending through the insulating interlayer 121, and contacting the source and drain regions of the active pattern 124, respectively.

In some embodiments, the insulating interlayer 121 may be partially etched to form contact holes exposing the source and drain regions. A second conductive layer may be formed on the insulating interlayer 121 to fill the contact holes. The second conductive layer may be etched until a portion of the insulating interlayer 121 is exposed, so as to form the source and drain electrodes 129 and 131 at the source and drain regions, respectively. Each of the source and drain electrodes 129 and 131 may include a metal, alloy, metal nitride, conductive metal oxide, a transparent conductive material, etc. For example, the source and drain electrodes 129 and 131 may include at least one of aluminum, an alloy containing aluminum, aluminum nitride, silver, an alloy containing silver, tungsten, tungsten nitride, copper, an alloy containing copper, nickel, an alloy containing nickel, chrome, chrome nitride, molybdenum, an alloy containing molybdenum, titanium, titanium nitride, platinum, tantalum, tantalum nitride, neodymium, scandium, strontium ruthenium oxide, zinc oxide, indium tin oxide, tin oxide, indium oxide, gallium oxide, indium zinc oxide, etc. In some embodiments, each of the source and drain electrodes 129 and 131 may be formed having a single layer structure or a multi-layer structure. The single layer structure or multi-layer structure may include a metal film, alloy film, metal nitride film, conductive metal oxide film, and/or a transparent conductive film.

The source and drain electrodes 129 and 131 on the insulating interlayer 121 constitute in part the elements of the switching device. As described previously, the switching device may include the TFT having the active pattern 124, gate insulating layer 119, gate electrode 127, source electrode 129, and drain electrode 131.

An insulating layer 132 may be disposed on the insulating interlayer 121 covering the source and drain electrodes 129 and 131. The insulating layer 132 may be formed having a single layer structure or a multi-layer structure. The multi-layer structure may include at least two insulating films. In some embodiments, a planarization process may be performed on the insulating layer 132 to enhance the flatness of the insulating layer 132. For example, the surface of the insulating layer 132 may be planarized to a substantially level surface using a chemical mechanical polishing (CMP) process, etch-back process, etc. The insulating layer 132 may include an organic material. For example, the insulating layer 132 may include at least one of a photoresist, acryl-based resin, polyimide-based resin, polyamide-based resin, siloxane-based resin, etc. In some embodiments, the insulating layer 132 may include an inorganic material. In those embodiments, the insulating layer 132 may include at least one of silicon oxide, silicon nitride, silicon oxynitride, silicon oxycarbide, aluminum, magnesium, zinc, hafnium, zirconium, titanium, tantalum, aluminum oxide, titanium oxide, tantalum oxide, magnesium oxide, zinc oxide, hafnium oxide, zirconium oxide, titanium oxide, etc.

The insulating layer 132 may be partially etched using a photolithography process (or an etching process using an additional etching mask such as a hard mask), so as to form a contact hole 133 through the insulating layer 132. The contact hole 133 may be formed partially exposing the drain electrode 131 of the switching device. In some embodiments, the contact hole 133 may have a sidewall inclined by a predetermined angle relative to the first substrate 113. For example, the contact hole 133 may have an upper width that is substantially larger than a lower width.

A first electrode 136 may be disposed on the insulating layer 132 so as to fill the contact hole 133. Thus, the first electrode 136 may be formed in contact with the drain electrode 131 exposed by the contact hole 133. In some embodiments, a contact, plug, or pad may be formed in the contact hole 133, and the first electrode 136 is then formed on the contact, plug, or pad. In those embodiments, the first electrode 136 may be electrically connected to the drain electrode 131 through the contact, plug, or pad.

The first electrode 136 may include a reflective material or a transparent material, depending on the emission type of the display device. For example, the first electrode 136 may include at least one of aluminum, an alloy containing aluminum, aluminum nitride, silver, an alloy containing silver, tungsten, tungsten nitride, copper, an alloy containing copper, nickel, an alloy containing nickel, chrome, chrome nitride, molybdenum, an alloy containing molybdenum, titanium, titanium nitride, platinum, tantalum, tantalum nitride, neodymium, scandium, strontium ruthenium oxide, zinc oxide, indium tin oxide, tin oxide, indium oxide, gallium oxide, indium zinc oxide, etc. In some embodiments, the first electrode 136 may be formed having a single layer structure or a multi-layer structure. The single layer structure or multi-layer structure may include a metal film, alloy film, metal nitride film, conductive metal oxide film, and/or transparent conductive film.

A pixel defining layer 139 may be disposed on the first electrode 136 and insulating layer 132. The pixel defining layer 139 may include an organic material or an inorganic material. For example, the pixel defining layer 139 may include a photoresist, acryl-based resin, polyacryl-based resin, polyimide-based resin, a silicon compound, etc. In some embodiments, the pixel defining layer 139 may be partially etched to form an opening partially exposing the first electrode 136. The opening of the pixel defining layer 139 may define a luminescent region and a non-luminescent region of the display device. For example, the opening of the pixel defining layer 139 may correspond to the luminescent region, while an area around the opening of the pixel defining layer 139 may correspond to the non-luminescent region.

A light emitting structure 142 may be disposed on a portion of the first electrode 136 exposed by the opening of the pixel defining layer 139. The light emitting structure 142 may be formed extending on a sidewall of the opening of the pixel defining layer 139. In some embodiments, the light emitting structure 142 may include an organic light emitting layer (EL), hole injection layer (HIL), hole transfer layer (HTL), electron transfer layer (ETL), electron injection layer (EIL), etc. In some embodiments, a plurality of organic light emitting layers may be formed using light emitting materials for generating different colors of light (such as red color light (R), green color light (G), or blue color light (B)) in accordance with the color pixels of the display device. In some other embodiments, the organic light emitting layers of the light emitting structure 142 may include a plurality of stacked light emitting materials for generating red color light, green color light, and blue color light, thereby emitting white color light.

A second electrode 145 may be disposed on the pixel defining layer 139 and light emitting structure 139. The second electrode 145 may include a transparent material or a reflective material, depending on the emission type of the display device. For example, the second electrode 145 may include at least one of aluminum, an alloy containing aluminum, aluminum nitride, silver, an alloy containing silver, tungsten, tungsten nitride, copper, an alloy containing copper, nickel, an alloy containing nickel, chrome, chrome nitride, molybdenum, an alloy containing molybdenum, titanium, titanium nitride, platinum, tantalum, tantalum nitride, neodymium, scandium, strontium ruthenium oxide, zinc oxide, indium tin oxide, tin oxide, indium oxide, gallium oxide, indium zinc oxide, etc. In some embodiments, the second electrode 145 may be formed having a single layer structure or a multi-layer structure. The single layer structure or multi-layer structure may include a metal film, alloy film, metal nitride film, conductive metal oxide film, and/or transparent conductive film.

A second substrate 153 may be disposed on the second electrode 145. The second substrate 153 may include a transparent insulating substrate. For example, the second substrate 153 may include a glass substrate, quartz substrate, transparent resin substrate, etc. In some embodiments, a predetermined space may be provided between the second electrode 145 and second substrate 153. The predetermined space may be filled with air or an inactive gas (such as nitrogen (N₂) gas). In some embodiments, a protection layer (not shown) may be additionally disposed between the second electrode 145 and second substrate 153. The protection layer may include a resin, such as photoresist, acryl-based resin, polyimide-based resin, polyamide-based resin, siloxane-based resin, etc.

### Description of Characteristics of Display Device Having Different Window Structures

Next, the reliability results of display devices having different window structures are provided. Specifically, the reliability results compare the yellow index and adhesion strength between three experimental examples and a comparative example.

### Experimental Example 1

In Experimental Example 1, a second transparent film layer (without a UV absorber having an organic pigment) is formed on a first transparent film layer. As mentioned previously, the organic pigment may include at least one of the following dyes: benzophenone-based dye, benzotriazol-based dye, triazine-based dye, azo-based dye, amino ketone-based dye, xanthene-based dye, and quinoline-based dye. In other words, the second transparent film layer in Experimental Example 1 does not include any of the aforementioned organic pigments.

Next, a third transparent film layer is formed on the second transparent film layer. After the third transparent film layer has been formed, a coating layer is formed on the third transparent film layer using at least one of a spray process, slit coating process, bar coating process, and spin coating process. A coating solution having a UV absorber and a blue pigment may be used for forming the coating layer. The blue pigment may include at least one of cobalt blue, ultramarine, azurite, and prussian blue. The resulting window structure is then disposed on a display device. Finally, the display panel and window structure are attached together by irradiating UV light having an intensity of about 3125 mW/cm² for 60 secs.

### Experimental Example 2

In Experimental Example 2, a second transparent film layer (without a UV absorber having an organic pigment) is formed on a first transparent film layer. Similar to Experimental Example 1, the organic pigment may include at least one of the following dyes: benzophenone-based dye, benzotriazol-based dye, triazine-based dye, azo-based dye, amino ketone-based dye, xanthene-based dye, and quinoline-based dye. Thus, the second transparent film layer in Experimental Example 2 does not include any of the aforementioned organic pigments.

Next, a third transparent film layer is formed on the second transparent film layer. After the third transparent film layer has been formed, a coating layer is formed on the third transparent film layer using at least one of a spray process, slit coating process, bar coating process, and spin coating process. A coating solution having a UV absorber and a colorless pigment may be used for forming the coating layer. The resulting window structure is then disposed on a display device. Finally, the display panel and window structure are attached together by irradiating UV light having an intensity of about 3125 mW/cm² for 60 secs.

### Experimental Example 3

In Experimental Example 3, a second transparent film layer (including a UV absorber having an organic pigment) is formed on a first transparent film layer. As mentioned above, the organic pigment may include at least one of the following dyes: benzophenone-based dye, benzotriazol-based dye, triazine-based dye, azo-based dye, amino ketone-based dye, xanthene-based dye, and quinoline-based dye. In other words, the second transparent film layer in Experimental Example 3 may include at least one of the aforementioned organic pigments.

Next, a third transparent film layer is formed on the second transparent film layer. The resulting window structure is then disposed on a display device. Finally, the display panel and window structure are attached together by irradiating UV light having an intensity of about 3125 mW/cm² for 60 secs twice (i.e. 2×60 secs).

### Comparative Example

In the Comparative Example, a second transparent film layer (including a UV absorber having an organic pigment) is formed on a first transparent film layer. As mentioned above, the organic pigment may include at least one of the following dyes: benzophenone-based dye, benzotriazol-based dye, triazine-based dye, azo-based dye, amino ketone-based dye, xanthene-based dye, and quinoline-based dye. Thus, the second transparent film layer in the Comparative Example may include at least one of the aforementioned organic pigments.

Next, a third transparent film layer is formed on the second transparent film layer. The resulting window structure is then disposed on a display device. Finally, the display panel and window structure are attached together by irradiating UV light having an intensity of about 3125 mW/cm² for 60 secs.

TABLE 1 below summarizes the measurement results of the yellow index and adhesion for the Experimental Examples and Comparative Example. The adhesion is measured at an interface between the display panel and window structure.

TABLE 1

| | Compar- | Experi- | Experi- | Experi- |
|---|---|---|---|---|
| | ative | mental | mental | mental |
| | Example | Example 1 | Example 2 | Example 3 |
| yellow index | 1.3 | 1.6 | 2.9 | 1.3 |
| adhesion between the | delami- | adhesion | adhesion | delami- |
| display panel and the | nation | | | nation |
| window structure | | | | |

The reliability of a display device may be improved by having low yellow index and good adhesion between the display panel and the window structure. Referring to TABLE 1, although the Comparative Example and Experimental Example 3 have low yellow index, the adhesion between the display panel and window structure is poor (as indicated by delamination occurring at the interface between the display panel and window structure). On the other hand, Experimental Examples 1 and 2 show good adhesion between the display panel and window structure. As mentioned previously, Experimental Examples 1 and 2 include a coating layer, whereas the Comparative Example and Experimental Example 3 do not include a coating layer. Thus, adhesion between the display panel and window structure may be improved when the window structure includes a coating layer.

Comparing Experimental Examples 1 and 2, it is observed that Experimental Example 1 has a lower yellow index than Experimental Example 2. In other words, Experimental Example 1 has an improved yellow index relative to Experimental Example 2.

In Experimental Examples 1 and 2, a UV absorber having an organic pigment is omitted from the second transparent film layer; a coating layer including a UV absorber is formed on a third transparent film layer; and the UV irradiation intensity and time is the same in both examples. However, the type of pigment used in the coating layer is different between Experimental Examples 1 and 2. Specifically, a blue pigment is used in the coating layer in Experimental Example 1, and a colorless pigment is used in the coating layer in Experimental Example 2. Thus, the yellow index may be improved when a blue pigment is used in the coating layer. Accordingly, the reliability of a display device may be improved using the window structure of Experimental Example 1 (in which a blue pigment is used in the coating layer).

In addition, one of ordinary skill in the art will appreciate that the window structure of Experimental Example 1 may be applied to various types of electronic devices having a display panel.

While the inventive concept has been described in connection with what is presently considered to be practical exemplary embodiments, it is to be understood that the inventive concept is not limited to the disclosed embodiments, but, on the contrary, is intended to cover various modifications and equivalent arrangements included within the spirit and scope of the disclosure.

What is claimed is:

1. A window structure comprising:
a first transparent film layer;
a second transparent film layer disposed on the first transparent film layer;
a third transparent film layer disposed on the second transparent film layer; and
a coating layer disposed on an upper surface of the window structure.

2. The window structure of claim 1, wherein the coating layer has a horizontal width and a longitudinal width that are substantially the same as a horizontal width and a longitudinal width of the first through third transparent film layers, respectively.

3. The window structure of claim 2, wherein the coating layer includes a UV absorber having an organic pigment, the organic pigment including at least one of a benzophenone-based dye, a benzotriazol-based dye, a triazine-based dye, an azo-based dye, an amino ketone-based dye, a xanthene-based dye, a quinoline-based dye, and an anthraquinone-based dye.

4. The window structure of claim 3, wherein the coating layer includes a blue pigment, the blue pigment including at least one of cobalt blue (CoAₗ₂O₄), ultramarine (Na₇Al₆Si₆O₂₄S₃), azurite (Cu₃(CO₃)₂(OH)₂), and prussian blue (Fe₄[Fe(CN)₆]₃).

5. The window structure of claim 1, wherein the first and third transparent film layers include at least one of polycarbonate (PC), polyethylene terephthalate (PET), and polymethyl methacrylate (PMMA), and the second transparent film layer includes a silicone elastomer.

6. The window structure of claim 5, wherein a UV absorber having an organic pigment is omitted from the second transparent film layer, the organic pigment including at least one of a benzophenone-based dye, a benzotriazol-based dye, a triazine-based dye, an azo-based dye, an amino ketone-based dye, a xanthene-based dye, and a quinoline-based dye.

7. The window structure of claim 1, further comprising:
a first adhesive member disposed between the first transparent film layer and the second transparent film layer; and
a second adhesive member disposed between the second transparent film layer and the third transparent film layer.

8. The window structure of claim 7, wherein the first and second adhesive members include at least one of an optically clear adhesive (OCA) and a super view resin (SVR).

9. The window structure of claim 1, further comprising:
a coating layer extending from the upper surface of the window structure so as to cover both sides of the window structure.

10. A method of manufacturing a display device, the method comprising:
forming a window structure on a display panel, wherein the display panel includes a switching device, a first electrode, a light emitting structure, and a second electrode, and
forming the window structure includes:
forming a first transparent film layer on the display panel;
forming a second transparent layer on the first transparent film layer;
forming a third transparent layer on the second transparent layer; and
forming a coating layer on an upper surface of the window structure.

11. The method of claim 10, wherein the coating layer has a horizontal width and a longitudinal width that are substantially the same as a horizontal width and a longitudinal width of the first through third transparent film layers, respectively.

12. The method of claim 11, wherein forming the coating layer comprises:
coating the coating solution using at least one of a spray process, a slit coating process, a bar coating process, and a spin coating process; and
removing a solvent from the coating solution by a baking process,
wherein the coating solution includes a blue pigment and a UV absorber having an organic pigment, the organic pigment including at least one of a benzophenone-based dye, a benzotriazol-based dye, a triazine-based dye, an azo-based dye, an amino ketone-based dye, a xanthene-based dye, a quinoline-based dye, and an anthraquinone-based dye, and the blue pigment including at least one of cobalt blue, ultramarine, azurite, and prussian blue.

13. The method of claim 10, wherein the first and third transparent film layers include at least one of polycarbonate, polyethylene terephthalate, and polymethyl methacrylate, and the second transparent film layer includes a silicone elastomer, and
wherein a UV absorber having an organic pigment is omitted from the second transparent film, the organic pigment including at least one of a benzophenone-based dye, a benzotriazol-based dye, a triazine-based dye, an azo-based dye, an amino ketone-based dye, a xanthene-based dye, and a quinoline-based dye.

14. The method of claim 13, further comprising:
forming a first adhesive member between the first transparent film layer and the second transparent film layer; and
forming a second adhesive member between the second transparent film layer and the third transparent film layer.

15. The method of claim 14, further comprising:
forming a third adhesive member between the display panel and the window structure, wherein the display panel is attached to the window structure using the third adhesive member.

16. The method of claim 15, wherein the first through third adhesive members include at least one of an optically clear adhesive (OCA) and a super view resin (SVR).

17. The method of claim 10, further comprising:
forming a coating layer extending from the upper surface of the window structure so as to cover both sides of the window structure.
